(19) United States
(12) Patent Application Publication
(10) Pub. No.: US 2002/0092435 A1
(43) Pub. Date: Jul. 18, 2002

(54) Method for cleaning of the surface of a cylinder

(76) Inventor: Tilo Steinborn, Meissen (DE)

Correspondence Address: Eva Tan, Goodwin Procter L.L.P., 7 Becker Farm Road, Roseland, NJ, 07068, US

(21) Appl. No.: 10/051,330

(22) Filed: Jan. 17, 2002

(30) Foreign Application Priority Data
Jan. 17, 2001 (DE) 101 01 835.5

(51) Int. Cl. B41F 35/00; B41L 41/00

(52) U.S. Cl. 101/424

(57) ABSTRACT

The invention relates to a method for cleaning the surface of a cylinder in a printing press with a blanket treated with a solvent of high viscosity, taken from a supply roll, brought into operating contact with the surface to be cleaned by pressing means and subsequently rolled up in a roll with the soiled blanket.

Task of the invention is a method for complication-free cleaning during processing of all printing materials

The task is solved according to the invention by an optional additional application of a cleaning medium for resolution of the soiling to the surface to be cleaned. The cleaning medium and the resolved soiling are taken up and removed by blanket treated with a solvent.

### FIELD OF INVENTION

The invention relates to a method for cleaning the surface of a cylinder in a printing press with a blanket treated with a solvent of high viscosity, taken from a supply roll, brought into operating contact with the surface to be cleaned by pressing means and subsequently rolled up in a roll with the soiled blanket.

### BACKGROUND OF INVENTION

A method with a blanket on a supply roll treated with a solvent of high viscosity, which eliminates the usual dampening of the blanket or the cylinder surface before or during the cleaning process is known from EP 747 218 B1. This method can be used without any complications when processed printing material causing only less soiling. The solvent in the blanket is insufficient for cleaning with the blanket without residue if materials like for instance cardboard causing high and sticky soiling.

### SUMMARY DESCRIPTION OF INVENTION

Task of the invention is a method for complication-free cleaning during the processing of all printing materials.

The task is solved according to the invention by a method for cleaning the surface of cylinders with a blanket treated with a solvent of high viscosity, which can be used also effectively for processing of printing material causing a high soiling.

The task is solved according to the invention by an optional additional application of a cleaning medium for resolution of the soiling on the surface to be cleaned. The cleaning medium and the resolved soiling are taken up and removed by blanket treated with solvent.

### BRIEF DESCRIPTION OF THE DRAWINGS

The invention is described below in greater detail by an embodiment of the invention, by reference being had to the drawing, wherein:

FIG. 1: Schematic of cylinders of a printing unit with a cleaning device in side view

FIG. 2: Schematic of a cleaning device in side view.

### DETAILED DESCRIPTION

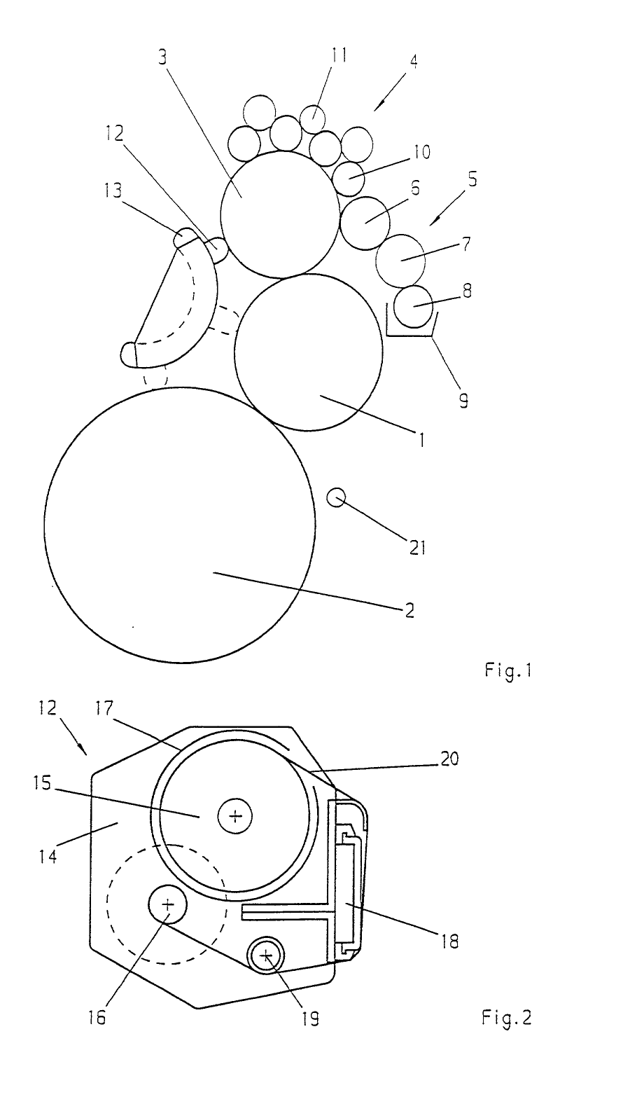

FIG. 1 shows a blanket cylinder 1 with an impression cylinder 2 and a plate cylinder 3. The plate cylinder 3 is allocated to an inking unit 4 and a dampening unit 5. The dampening unit 5 comprises of a dampening form roller 6, a bridging roller 7, a dampening duct roller 8 and a dampening pan 9. The inking unit 4 comprises of inking form rollers 10 and rider rollers 11. The cleaning device 12 a functional unit carried on both sides of the printing press in a guide 13 and moveable by not shown means to get it in contact with the plate cylinder 3 or the blanket cylinder 1 or the impression cylinder 2. The cleaning device 12 comprises of side frames 14 carrying the supply roll 15 with the blanket 20 in a housing 17. The blanket 20 is treated in known manner with a solvent of high viscosity and moved along a pressing element 18 and a guiding roll 19 to the soiled blanket roll 16.

For cleaning of the cylinders 1, 2, and 3 the inking unit 4 and the dampening unit 5 are disengaged from the plate cylinder 3, the blanket cylinder 1 from the plate cylinder 2 and the impression cylinder 2 in a known manner. Subsequently the cleaning device 12 is moved in the guide 13 into a position opposite to the plate cylinder 3. The pressing element 18 is now pressurized and gets the blanket 20 in operating contact with the surface to be cleaned. The solvent contained in the blanket 20 solves and the blanket takes up the soiling. The soiled blanket is rolled up cycle-wise to the soiled blanket roll 16 by not shown means and a fresh blanket gets in contact with the surface to be cleaned. Blanket cylinder 1 and impression cylinder 2 are cleaned analogue.

The soiling on the blanket cylinder 1 resulting from processing cardboard is very sticky so that the soiling can not be resolved and removed sufficiently by the solvent in the blanket 20. The supply of additional cleaning media to the blanket cylinder 1 is therefore necessary to enable the required cleaning in a short time. For this purpose the blanket cylinder 1 is engaged to the plate cylinder 3, which is engaged to the dampening unit 5 so that the blanket cylinder 1 is dampened though the plate cylinder 3. This dampening of the blanket cylinder surface resolves the dried soiling and supports its removal by the blanket 20 treated with a solvent.

It is also feasible to apply the additional cleaning media with an application device 21 allocated to the blanket cylinder 1. The additional cleaning medium is absorbed and removed by the blanket 20.

If heavy soiling occurs on the plate cylinder 3, the plate cylinder 3 is disengaged from the blanket cylinder 1 and additional dampening solution is brought to the plate cylinder 3.

If heavy soiling occurs on the impression cylinder 2, the blanket cylinder 1 is engaged to the impression cylinder 2 after cleaning of the plate cylinder 3 and the blanket cylinder 1 so that dampening solution is fed from the dampening unit 5 via the plate cylinder 3 and the blanket cylinder 1 to the impression cylinder 2. It is also feasible to apply additional cleaning medium through an application device 21 to the blanket cylinder 1 and from there to the impression cylinder 2.

We claim:

1. Method for cleaning the surface of a cylinder in a printing press with a blanket treated with a solvent of high viscosity, taken from a supply roll, brought into operating contact with the surface to be cleaned by pressing means and subsequently rolled up in a roll with the soiled blanket
whereby
a cleaning medium for solving the soiling is applied to the surface to be cleaned and the solved soiling is taken up and removed by a blanket treated with a solvent.

2. Method according to claim 1,
whereby
the additional cleaning medium is applied by an application device.

3. Method according to claim 1,
whereby
the cleaning medium is the dampening solution.

4. Method according to claim 1,
whereby
the dampening solution is provided by the dampening unit.

5. Method according to claim 1,
whereby
the dampening solution is applied to the plate cylinder and transferred from this to the impression cylinder.
